(19) United States
(12) Patent Application Publication
(10) Pub. No.: US 2026/0207015 A1
(43) Pub. Date: Jul. 23, 2026

(54) QUICK-MOUNT SHOWER DOOR SLIDING STRUCTURE COMPRISING SHORT WATER BLOCKING MEMBER, AND SHOWER DOOR COMPRISING SAME

(71) Applicant: IDEAL SANITARY WARE CO., LTD., Foshan, Guangdong (CN)

(72) Inventor: Wuxiang WEI, Foshan (CN)

(21) Appl. No.: 19/157,786

(22) PCT Filed: Jun. 5, 2023
(86) PCT No.: PCT/CN2023/098413

§ 371 Date: Sep. 25, 2025

(51) Int. Cl. A47K 3/34; E05D 15/06

(52) U.S. Cl. CPC A47K 3/34; E05D 15/0656; E05Y 2600/56; E05Y 2800/12; E05Y 2800/428; E05Y 2800/744; E05Y 2900/114

(57) ABSTRACT

Provided are a quick-mount shower door sliding structure comprising a short water blocking member and a shower door comprising the same. The sliding structure comprises a fixation component, a sliding component and a water blocking plate. The fixation component includes a fixation plate and a guide portion, and the fixation plate is configured for mounting the sliding structure on the ground. The sliding component includes a guide groove with an opening facing towards the ground and a mounting groove with an opening facing away from the ground. The mounting groove is configured to accommodate the bottom of a movable door panel of the shower door to fix the movable door panel. When the guide portion is perpendicular to the fixation plate, the guide grooves are adapted to be sleeved on the guide portion, so that the guide groove can slide in the length direction of the guide portion. When the bottom of the water blocking plate is in contact with the ground, the gap between the sliding component and the ground is blocked to prevent water from flowing out from the bottom of the shower door. With the sliding component, water can be blocked in real-time during movement.

### FIELD

The present application relates to the technical field of bathroom equipment, and in particular to a quick-mount shower door sliding structure comprising a short water blocking member, and a shower door comprising the same.

### BACKGROUND

At present, use of a shower room for wet-dry separation is becoming increasingly common in the field of home decoration. The shower room is generally provided with a shower door with a glass plate. According to different installation requirements, the existing shower door has a linear partition, where a rail is mounted and the glass plate is hoisted, and one or more glass plates are slidable along the upper rail.

However, in actual use, movement of the shower door affects a water blocking effect of the shower room, which easily leads to leakage of water in the shower room to the exterior.

### SUMMARY

In order to solve the technical problem that a water blocking effect of a shower room is affected when a shower door moves, a quick-mount shower door sliding structure comprising a short water blocking member, and a shower door comprising the same are provided according to the present application.

According to an aspect of the present application, a quick-mount shower door sliding structure comprising a short water blocking member is provided. The sliding structure includes: a fixation component, the fixation component includes a fixation plate and a guide portion, the fixation plate is configured for mounting the sliding structure on the ground, and the guide portion is connected with the fixation plate; a sliding component, the sliding component includes a guide groove with an opening facing the ground and a mounting groove with an opening facing away from the ground, the mounting groove is configured to accommodate a lower portion of a movable door panel of the shower door to fix the movable door panel, and the guide groove is sleeved to the guide portion in a case that the guide portion is perpendicular to the fixation plate, allowing the guide groove to be slidable along a length direction of the guide portion and the movable door panel to be slidable relative to the fixation plate; a water blocking plate, the water blocking plate is connected with the mounting groove, and a bottom of the water blocking plate is in contact with the ground, to block a gap between the sliding component and the ground thereby prevent water from flowing out from a bottom of the shower door.

Alternatively, the sliding component includes a main plate, two first side plates and two second side plates. The main plate is parallel to the fixation plate, the two first side plates are spaced apart on a side of the main plate close to the ground, the two second side plates are spaced apart on a side of the main plate away from the ground, wherein the guide groove is defined by the two first side plates and the main plate, and the mounting groove is defined by the two second side plates and the main plate; wherein the water blocking plate and the first side plates are spaced on a same side of the main plate, and the water blocking plate is connected with a second side plate located on an outer side of the movable door panel; and wherein in a case that the guide portion is perpendicular to the fixation plate, a height of the water blocking plate is greater than a height of the guide portion, and a height of the guide portion is greater than heights of the first side plates. In this way, the movable door panel can slide smoothly, and the water blocking plate can cover the gap between the bottom of the sliding component and the ground, ensuring the water blocking effect.

Alternatively, the water blocking plate includes a first portion connected with the second side plates and a second portion in contact with the ground, and the second portion is bent relative to the first portion toward a side close to the guide portion. The bending configuration can thereby enable backflow of water due to the water blocking plate.

Alternatively, the water blocking plate further includes an adjusting member, the adjusting member is arranged between the first portion and the second portion, and is configured to adjust the height of the water blocking plate to adjust a sealing degree between the water blocking plate and the ground. The height adjustment by the adjust member achieves a balance between a water blocking function and smoothness of the movement.

Alternatively, the fixation component further includes a limiting member arranged on an end of the fixation plate away from the guide portion; the sliding structure further includes a water baffle arranged on the limiting member to prevent water from flowing out from the bottom of the shower door; wherein the water blocking plate includes a baseplate and a faceplate. The baseplate is configured to be in contact with the ground, the faceplate is arranged on a side of the baseplate away from the ground, the baseplate includes a first side surface close to the water blocking plate and a second side surface away from the water blocking plate, a bottom surface of the faceplate is connected with the first side surface, and a top surface of the faceplate is connected with the second side surface through an arc surface. A plurality of teeth are provided on a side of the baseplate in contact with the ground, to increase a contact area between the baseplate and the ground. With such configuration, the waterproof effect by the water blocking plate is further improved.

Alternatively, the water blocking plate is detachably connected with a second side plate located on the outer side of the movable door panel, so as to facilitate replacement of the water blocking plate, and save cost.

Alternatively, the shower door includes two movable door panels, the sliding component includes two guide grooves in one-to-one correspondence with the two movable door panels, and the fixation component further includes two hinge portions horizontally arranged on two ends of the fixation plate respectively; the guide portion further includes two connecting rods in one-to-one correspondence with the two hinge portions, one of the connecting rods has an end hinged to one of the hinge portions, and the connecting rod is switched between being parallel to the fixation plate and being perpendicular to the fixation plate by rotating the connecting rod relative to the hinge portion; the guide portion further includes two self-locking sheets in one-to-one correspondence with the two connecting rods, one of the self-locking sheets has an end hinged to the other end of the one of the connecting rods, and the self-locking sheet is switched between being parallel to the fixation plate and being perpendicular to the fixation plate by rotating the self-locking sheet relative to the connecting rod; in a case that the one of the connecting rods and the self-locking sheet corresponding to the connecting rod are both rotated to be perpendicular to the fixation plate, a free end of the self-locking sheet away from the connecting rod is located in a corresponding one of the guide grooves, allowing the guide groove to be slidable along a length direction of the self-locking sheet. The arrangement of the two rotatable guide portions facilitates mounting and detaching.

Alternatively, the shower door includes two movable door panels, the sliding component includes two guide grooves in one-to-one correspondence with the two movable door panels, and an end of the fixation plate is provided with a hinge portion in a horizontal direction; the guide portion includes a guide plate, the guide plate is arranged on a side of the fixation plate away from the hinge portion, and the guide plate extends vertically from the fixation plate to a side away from the ground, and a free end of the guide plate away from the fixation plate is located in a corresponding one of the guide grooves, allowing the guide groove to be slidable along a length direction of the guide plate; the guide portion further includes a connecting rod and a self-locking sheet, an end of the connecting rod is hinged to the hinge portion, the other end of the connecting rod is hinged to the self-locking sheet, the connecting rod is switched between being parallel to the fixation plate and being perpendicular to the fixation plate by rotating the connecting rod relative to the hinge portion, and the self-locking sheet is switched between being parallel to the fixation plate and being perpendicular to the fixation plate by rotating the self-locking sheet relative to the connecting rod; in a case that the connecting rod and the self-locking sheet are both rotated to be perpendicular to the fixation plate, a free end of the self-locking sheet away from the connecting rod is located in a corresponding one of the guide grooves, allowing the guide groove to be slidable along a length direction of the self-locking sheet. The rotatable guide portion facilitates mounting and detaching.

Alternatively, the shower door includes two movable door panels, and the sliding component includes two guide grooves in one-to-one correspondence with the two movable door panels; the guide portion includes two guide plates, the two guide plates are spaced apart on the fixation plate, each guide plate extends vertically from the fixation plate toward a side away from the ground, and a free end of each guide plate away from the fixation plate is located in a corresponding one of the guide grooves, allowing the guide groove to be slidable along a length direction of the guide plate. Arrangement of the two guide plates achieves better stability.

Alternatively, a positioning recess is defined on a side of each hinge portion away from the ground; two notches are defined at the free end of the self-locking sheet, and a limiting tooth is provided at a bottom of at least one of the notches; and in a case that the self-locking sheet is perpendicular to the fixation plate, the limiting tooth is in contact with the positioning recess to keep the self-locking sheet perpendicular to the fixation plate. With the limiting tooth and the positioning recess, the self-locking sheet can be locked.

According to another aspect, a shower door is provided according to an embodiment of the present application. The shower door includes the sliding structure according to any of the above embodiments and a movable door panel, where the movable door panel is located in the mounting groove.

The quick-mount shower door sliding structure comprising a short water blocking member is provided according to the present application. The sliding component is slidable relative to the fixation component through the sliding fit between the guide groove in the sliding component and the guide portion in the fixation component. The mounting groove is connected with the water blocking plate, so that the contact of the water blocking plate with the ground can prevent water from flowing out from the bottom of the shower door. Therefore, the sliding structure according to the embodiments can have a water blocking effect when the shower door moves, so that leakage of water in a shower room to the exterior due to the movement of the shower door is avoided.

In the shower door according to the embodiments of the present application, a side of the mounting groove in the sliding component is connected with the water blocking plate, so that the shower door can have a water blocking effect when the shower door moves. Thereby, leakage of water in a shower room to the exterior due to movement of the shower door is avoided.

### BRIEF DESCRIPTION OF THE DRAWINGS

The drawings described herein are for illustrative purposes only and are not intended to limit the scope of the present application in any way.

FIG. 1 shows a schematic view showing a mounting position of a quick-mount shower door sliding structure comprising a short water blocking member according to an embodiment of the present application;

FIG. 2 shows an assembly view of a first alternative structure of the sliding structure;

FIG. 3 shows an exploded view of the sliding structure in FIG. 2;

FIG. 4 shows a schematic view of an alternative structure of a sliding component and a water blocking plate viewed from a first perspective and a second perspective according to an embodiment of the present application;

FIG. 5 shows a schematic view of a first alternative structure of a fixation component and a guide portion after assembly viewed from a first perspective and a second perspective according to an embodiment of the present application;

FIG. 6 shows an assembly view of a second alternative structure of a quick-mount shower door sliding structure comprising a short water blocking member according to an embodiment of the present application;

FIG. 7 shows a schematic structural view of a self-locking sheet parallel to a fixation plate in the sliding structure in FIG. 6;

FIG. 8 shows an exploded view of the sliding structure in FIG. 6;

FIG. 9 shows a schematic view of a second alternative structure of a fixation component and a guide portion after assembly according to an embodiment of the present application;

FIG. 10 shows a schematic view of an alternative structure of the fixation component in FIG. 9 viewed from a first perspective and a second perspective;

FIG. 11 shows a schematic view of an alternative structure of a connecting rod viewed from a first perspective and a second perspective according to an embodiment of the present application;

FIG. 12 shows schematic views of two alternative structures of a self-locking sheet according to an embodiment of the present application;

FIG. 13 shows a third exploded view of a quick-mount shower door sliding structure comprising a short water blocking member according to an embodiment of the present application;

FIG. 14 shows a schematic view of a second alternative structure of a fixation component and a guide portion after assembly according to an embodiment of the present application;

FIG. 15 shows a schematic view of an alternative structure of the fixation component in FIG. 14 viewed from a first perspective and a second perspective;

FIG. 16 shows a schematic view of an alternative structure of a limiting member viewed from a first perspective and a second perspective according to an embodiment of the present application; and

FIG. 17 shows a schematic view of an alternative structure of a water baffle according to an embodiment of the present application.

Reference numerals in the drawings are listed as follows:

| | |
|---|---|
| 1 shower door; | 100 sliding structure; |
| 200 glass door; | 300 door frame; |
| 10 fixation component; | 20 sliding component; |
| 30 water blocking plate; | 110 fixation plate; |
| 111 hinge portion; | 1111 boss; |
| 1112 first reaming; | 1113 positioning recess; |
| 1114 first recess; | 112 through hole; |
| 120 guide portion; | 121 guide plate; |
| 122 connecting rod; | 1221 connecting portion; |
| 1222 blocking tooth; | 123 self-locking sheet; |
| 1231 second recess; | 1232 second reaming; |
| 1233 notch; | 1234 limiting tooth; |
| 40 water baffle; | 410 baseplate; |
| 420 faceplate; | 430 arc surface; |
| 440 toothed structure; | 210 guide groove; |
| 220 mounting groove; | 230 main plate; |
| 201 first side plate; | 202 second side plate; |
| 310 first portion; | 320 second portion; |
| 140 limiting member; | 141 limiting rib; |
| 142 cut groove; | 143 connecting member; |
| 50 cover body. | |

### DETAILED DESCRIPTION OF THE EMBODIMENTS

The following description is merely exemplary in nature and is not intended to limit the present application and an application or use thereof. It should be understood that the corresponding reference numerals in the drawings always indicate the same or corresponding parts and features.

Example embodiments are provided so that the present disclosure is sufficient and the scope is fully communicated to those skilled in the art. Many specific details, such as examples of specific components, devices, and methods, are described to provide a comprehensive understanding of embodiments of the present application. It is obvious to those skilled in the art that the example embodiments can be implemented in many different forms without adopting specific details, and none of them should be interpreted as limiting the scope of the present application. In some exemplary embodiments, well-known methods, well-known device structures, and well-known techniques are not described in detail.

When an element or layer is referred to as being “on” or “bonded to”, “connected to” or “coupled to” to another element or layer, the element or layer may be directly on the other element or layer, or directly bonded, connected or coupled to the other element or layer, or there may be intermediate elements or layers. On the contrary, when an element is referred to as being “directly on” or “directly bonded to”, “directly connected to” or “directly coupled to” another element or layer, there is no intermediate element or layer. Other words used to describe a relationship between elements should be interpreted in the same way (for example, words “between . . . ” versus “directly between . . . ”, “adjacent to” versus “directly adjacent to”, etc.). As used herein, term “and/or” includes any and all combinations of one or more of the associated listed items.

Although the terms first, second, third, etc. are used herein to describe different elements, components, regions, layers and/or parts, these elements, components, regions, layers and/or parts should not be limited by these terms. These terms can only be used to distinguish one element, component, region, layer and/or part from another element, component, region, layer and/or part. Terms such as “first”, “second” and other numerical terms, when used herein, do not mean order or sequence unless clearly indicated by the context. Thus, the first element, component, region, layer, or part discussed below can be referred to as the second element, component, region, layer, or part without departing from the teaching of the exemplary embodiments.

For an existing shower room, in order to facilitate installation by a user, a water blocking plate is placed at a doorsill of the shower room. However, movement of the shower door causes water waves, and the water waves overflows from the water blocking plate, resulting in leakage of water in a shower room to the exterior and even an overall leakage around a house. In a case where a height of the water blocking plate is increased to prevent water from overflowing from the water blocking plate, the user may accidentally kick the water blocking plate and has toe injury, resulting in reduced user experience.

In view of the above problems, a quick-mount shower door sliding structure comprising a short water blocking and a shower door comprising the same are provided according to embodiments of the present application, with which the above problems can be solved.

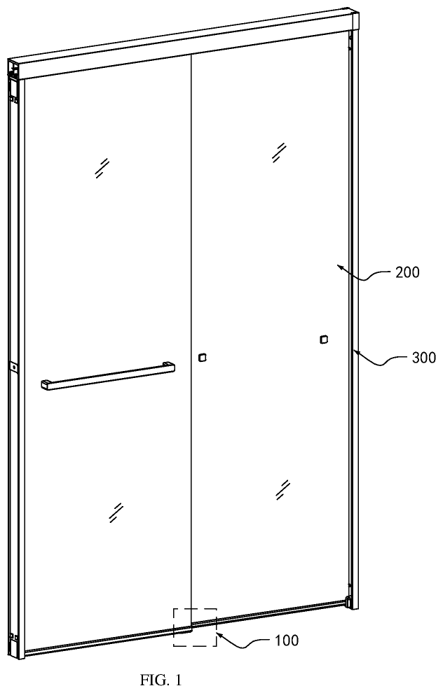

Reference is made to FIG. 1, which shows a schematic view showing a mounting position of a quick-mount shower door sliding structure comprising a short water blocking member according to an embodiment of the present application. According to an embodiment of the present application, a shower door 1 includes a door frame 300 and glass doors 200. A mounting space is defined by the door frame 300, the glass doors 200 are arranged in the mounting space, and a lower end of the glass door 200 is inserted in a sliding structure 100. The number of the glass doors 200 according to an embodiment of the present application is at least two, and at least one of the glass doors 200 is a movable glass door 200. For example, in some embodiments, the shower door 1 may include a movable glass door 200 and a fixed glass door 200. In some embodiments, the shower door 1 may include two movable glass doors (that is, movable door panels) 200. In some embodiments, the shower door 1 may include three movable glass doors 200, and so on. A specific arrangement of the shower door 1 may be arranged according to an actual situation, which is not specifically limited herein. The shower door 1 including two movable glass doors 200 is taken as an example in the embodiment of the present application for explanation, and should not be understood as a limitation on the shower door 1. In addition, the movable glass door 200 is slidable relative to the ground, and the fixed glass door 200 cannot slide relative to the ground.

The sliding structure 100 is arranged at a bottom of the movable glass door 200.

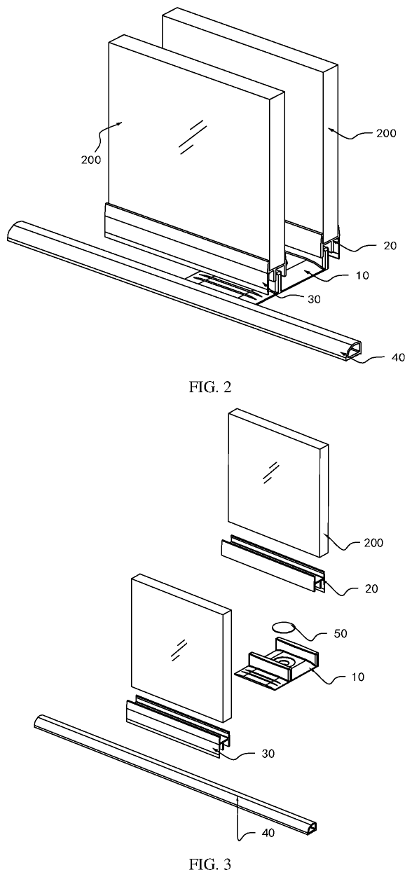

Reference is further made to FIG. 2 to FIG. 3. FIG. 2 shows an assembly view of a first alternative structure of a sliding structure according to an embodiment of the present application. FIG. 3 shows an exploded view of the sliding structure in FIG. 2. A quick-mount shower door sliding structure 100 comprising a short water blocking member is provided according to an embodiment of the present application. The shower door 1 includes the glass doors 200. The sliding structure 100 includes a fixation component 10, a sliding component 20 and a water blocking plate 30. The fixation component includes a fixation plate 110 and a guide portion 120. The fixation plate 110 is configured to mount the sliding structure 100 on the ground, and the guide portion 120 is connected with the fixation plate 110. The sliding component 20 includes a guide groove 210 with an opening facing the ground and a mounting groove 220 with an opening facing away from the ground. The mounting groove 220 is configured to accommodate a lower portion of the glass door 200 to fix the glass door 200. In a case that the guide portion 120 is perpendicular to the fixation plate 110, the guide groove 210 is sleeved to the guide portion 120, to allow the guide groove 210 to be slidable along a length direction of the guide portion 120 and thereby the glass door 200 to be slidable relative to the fixation plate 110. The water blocking plate 30 is connected with the mounting groove 220. A bottom of the water blocking plate 30 is in contact with the ground, to block a gap between the sliding component 20 and the ground and prevent water from flowing out from a bottom of the shower door 1. In the embodiment of the present application, the sliding component 20 is slidable relative to the fixation component 10 through a sliding fit between the guide groove 210 in the sliding component 20 and the guide portion 120 in the fixation component 10. In addition, the mounting groove 220 is connected with the water blocking plate 30, so that the contact of the water blocking plate 30 with the ground can prevent the water from flowing out from the bottom of the shower door 1. Therefore, the sliding structure 100 in this embodiment can have a water blocking effect when the shower door 1 moves, so that leakage of water in a shower room to the exterior due to movement of the shower door 1 is avoided.

It should be noted that, the guide portion 120, the guide groove 210 and the mounting groove 220 are configured extending toward a moving direction. A length of the mounting groove 220 extending in the moving direction may be set based on an actual size of the lower portion of the glass door 200, as long as the mounting groove 220 can limit and fix the glass door 200. In addition, a length of the guide portion 120 extending in the moving direction may be set based on a distance that the glass door 200 needs to move, as long as the guide portion 120 can guide the guide groove 210 to a target position.

It can be understood that the length of the guide groove 210 extending in the moving direction and the length of the mounting groove 220 extending in the moving direction may be the same or different, based on an actual situation. For example, in some embodiments, in order to increase a stability of the movement of the glass door 200, the length of the guide groove 210 extending in the moving direction is set the same as the length of the mounting groove 220 extending in the moving direction, so as to avoid a situation that the center of gravity of the glass door 200 is unstable during the movement due to the length of the guide groove 210 being less than the length of the mounting groove 220, thereby improving a service life of the glass door 200. In other embodiments, the length of the guide groove 210 may be set based on the distance that the glass door 200 needs to move, under a condition of ensuring the stability of the movement of the glass door 200, thereby saving materials and reducing costs.

In some embodiments, the guide groove 210 has a semi-enclosed structure in a shape of “ [symbol] ” with an opening facing the ground. Therefore, there is a large adjustment space which facilitates mounting the guide groove 210 to the guide portion 120. In other embodiments, a sectional shape of the guide groove 210 may be set according to a sectional shape of the guide portion 120, so that the guide groove 210 can smoothly slide along the guide portion 120, and thereby the stability and smoothness of the sliding of the glass door 200 is improved. It should be noted that the guide groove 210 having the semi-enclosed structure in the shape of “ [symbol] ” is taken as an example in the embodiments of the present application, and should not be understood as a limitation on a structure of the guide groove 210.

In some embodiments, the mounting groove 220 has a semi-enclosed structure in a shape of “ [symbol] ” with an opening facing away from the ground, which facilitates mounting the glass door 200 to the guide portion 120. In other embodiments, a sectional shape of the mounting groove 220 may be set according to a sectional shape of the lower portion of the glass door 200, so that the mounting groove 220 can better wrap the lower portion of the glass door 200. Hence, the stability and safety of the sliding of the glass door 200 is ensured, and it is avoided that water on the glass door 200 flows down into the mounting groove 220 along the glass door 200 and results in accumulation of water in the mounting groove 220 to breed bacteria. It should be noted that the mounting groove 220 having the semi-enclosed structure in the shape of “ [symbol] ” is taken as an example in the embodiments of the present application, and should not be understood as a limitation on a structure of the mounting groove 220.

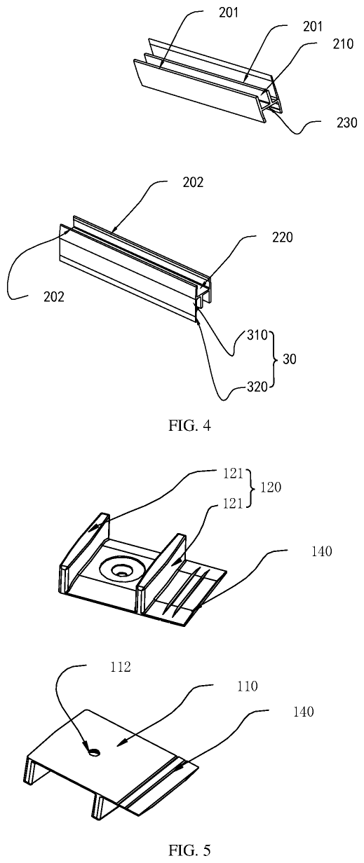

Reference is made to FIG. 4, which shows a schematic view of an alternative structure of a sliding component and a water blocking plate viewed from a first perspective and a second perspective according to an embodiment of the present application. It should be noted that the sliding component 20 according to the embodiment of the present application includes multiple guide grooves 210 and multiple mounting grooves 220, and the multiple guide grooves 210 and the multiple mounting grooves 220 are respectively arranged in one-to-one correspondence with the multiple glass doors 200. One guide groove 210 and one mounting groove 220 in the sliding component 20 are described in detail in the embodiment of the present application, and the description applies to other guide grooves 210 and other mounting grooves 220, and thus the other guide grooves 210 and other mounting grooves 220 are not described in detail here. For example, the sliding component 20 includes a main plate 230, two first side plates 201 and two second side plates 202. The main plate 230 is parallel to the fixation plate 110, and the two first side plates 201 are spaced apart on a side of the main plate 230 close to the ground, and the two second side plates 202 are spaced apart on a side of the main plate 230 away from the ground. The guide groove 210 is defined by the two first side plates 201 and the main plate 230, and the mounting groove 220 is defined by the two second side plates 202 and the main plate 230.

The water blocking plate 30 and the first side plates 201 are spaced on a same side of the main plate 230, and the water blocking plate 30 is connected with the second side plate 202 located on an outer side of the glass door 200. The outer side of the glass door 200 may be understood as a side of the glass door 200 arranged in an overflow direction of the water flow. Due to the connection between the water blocking plate 30 and the second side plates 202, the water blocking plate 30 can move following the second side plate 202 in real time, ensuring that the water does not flow out from below the first side plate 201 when the glass door 200 moves, so that overflowing is prevented.

In some embodiments, the water blocking plate 30 is integrally formed with the second side plates 202 on the outer side of the glass door 200, which can reduce processing procedures and save cost.

However, due to the abrasion of the water blocking plate 30 after long-term use, the water blocking effect of the water blocking plate 30 is weakened. Therefore, in order to solve this problem, in some embodiments, the water blocking plate 30 is detachably connected with the second side plates 202 located on the outer side of the glass door 200. With the detachable connection, the water blocking plate 30 can be replaced individually without replacing the entire sliding structure 100, so that the cost is saved. The detachable connection may be achieved by any one of adhesive, tenon-mortise structure, lock-catch structure, or concave-convex structure. A specific connection may be configured according to an actual situation, and is not specifically limited here.

The water blocking plate 30 may be arranged at an inclination relative to the second side plate 202, or may be arranged on the second side plate 202 and extending vertically toward the ground.

For example, in some embodiments, the water blocking plate 30 is arranged at an inclination relative to the second side plate 202 in a direction close to the guide portion 120. Water, when flows to the water blocking plate 30, can better flow back into a drainage groove under the action of the oblique surface in such oblique arrangement. An angle between the water blocking plate 30 and the second side plates 202 may be set according to an actual situation, as long as the water blocking plate 30 is in contact with the ground and achieves water blocking.

In some embodiments, the water blocking plate 30 and the first side plates 201 are all arranged perpendicular to the main plate 230, and the guide portion 120 is perpendicular to the fixation plate 110. That is, the second side plates 202 are arranged perpendicular to the main plate 230, and the water blocking plate 30 is arranged on the second side plate 202 and extending vertically toward the ground. The arrangement of the water blocking plate 30, the second side plates 202 and the first side plates 201 all perpendicular to the main plate 230 can facilitate installation.

A height of the water blocking plate 30 is greater than a height of the guide portion 120, and a height of the guide portion 120 is greater than a height of each first side plate 201. Hence, there is no gap between the water blocking plate 30 and the ground to ensure the water blocking effect, and a situation that the first side plates 201 are too long and effects smoothness of the movement of the glass door 200 can be avoided. It can be understood that the height refers to an orthogonal projected length in a direction perpendicular to the ground.

Referring to FIG. 4, the water blocking plate 30 includes a first portion 310 connected with the second side plates 202 and a second portion 320 in contact with the ground, and the second portion 320 is bent relative to the first portion 310 toward a side close to the guide portion 120. The first portion 310 ensures firmness of the connection to the second side plates 202. The bending of the second portion 320 enables backflow of water into a drainage groove, and adjust a sealing degree between the water blocking plate 30 and the ground to ensure that the sliding smoothness of the glass door 200 is not reduced due to too many contact surfaces between the water blocking plate 30 and the ground, and the water blocking effect is not reduced due to the gap between the water blocking plate 30 and the ground. An angle between the first portion 310 and the second portion 320 may be set according to an actual situation, which is not specifically limited here.

In addition, when the sliding structure 100 of the shower door 1 is mounted on different floors, the sealing degree between the water blocking plate 30 and the ground is different for the different floors, and even a gap may appear between the water blocking plate 30 and the ground, thus affecting the movement of the glass door 200 and the water blocking effect of the water blocking plate 30. In order to solve this problem, the water blocking plate 30 according to an embodiment of the present application further includes an adjusting member. The adjusting member is arranged between the first portion 310 and the second portion 320, and is configured to adjust the height of the water blocking plate 30 to adjust the sealing degree between the water blocking plate 30 and the ground. For example, if there is a gap between the water blocking plate 30 and the ground, the height of the water blocking plate 30 is increased by the adjusting member, so that the water blocking plate 30 blocks the gap between the sliding component 20 and the ground. If an excessive contact between the water blocking plate 30 and the ground affects the sliding of the glass door 200, the height of the water blocking plate 30 is reduced by the adjusting member, so as to ensure the smoothness of the sliding of the glass door 200.

In some embodiments, the adjusting member may be an angle adjuster, and the height of the water deflector 30 can be adjusted by adjusting an angle between the first portion 310 and the second portion 320. In other embodiments, the adjusting member has a segmented telescopic or deformable plate structure, and the height of the water blocking plate 30 is adjusted by increasing or decreasing a height of a plate structure connecting the first portion 310 with the second portion 320. In some other embodiments, the adjusting member may have a split detachable structure. For example, at least one V-notch is defined on the water blocking plate 30, and the height of the water blocking plate 30 can be adjusted by removing a part of the water blocking plate 30 from different V-notches.

In some embodiments, a material of the water blocking plate 30 is a soft glutinous material, which is elastic, can be deformed greatly under an action of a small external force, and can be restored to its original state after the external force is removed. Hence, the water blocking plate 30 is soft, easy to be bent and folded, and elastic. These characteristics ensures a contact degree between the water blocking plate 30 and the ground and ensures the movement of the glass door 200.

Reference is made to FIG. 5, which shows a schematic view of a first alternative structure of a fixation component and a guide portion after assembly viewed from a first perspective and a second perspective according to an embodiment of the present application. In some embodiments, the shower door 1 includes two glass doors 200, the sliding component 20 includes two guide grooves 210 in one-to-one correspondence with the two glass doors 200, and the guide portion 120 includes two guide plates 121. The two guide plates 121 are spaced apart on the fixation plate 110, and each guide plate 121 extends vertically from the fixation plate 110 toward a side away from the ground. A free end of each guide plate 121 away from the fixation plate 110 is located in a corresponding guide groove 210, to allow the guide groove 210 to be slidable along a length direction of the guide plate 121.

Heights of the two guide plates 121 may be the same or different, which needs to be set according to an actual situation, as long as a height of the water blocking plate 30 corresponding to the guide portion 120 is greater than the height of the guide portion 120, and the height of the guide portion 120 is greater than the height of a corresponding first side plate 201.

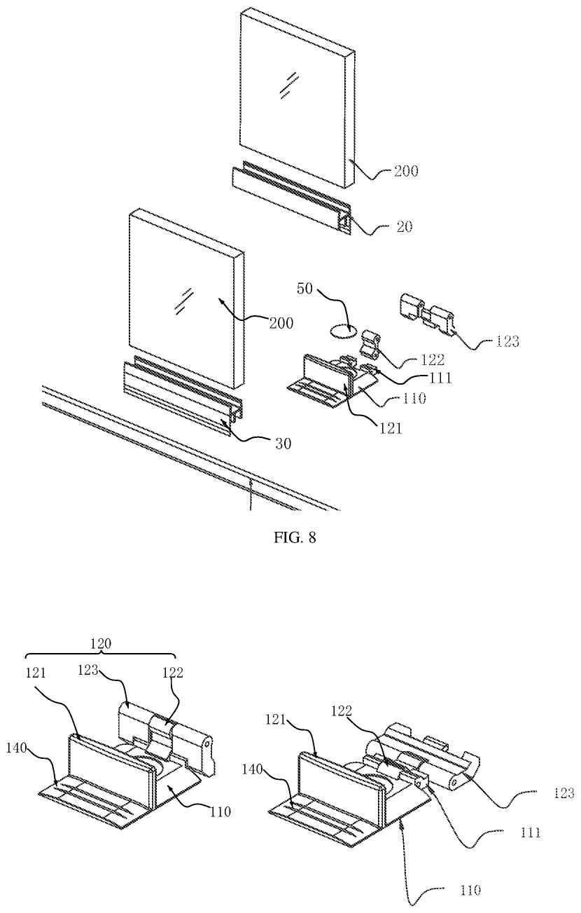

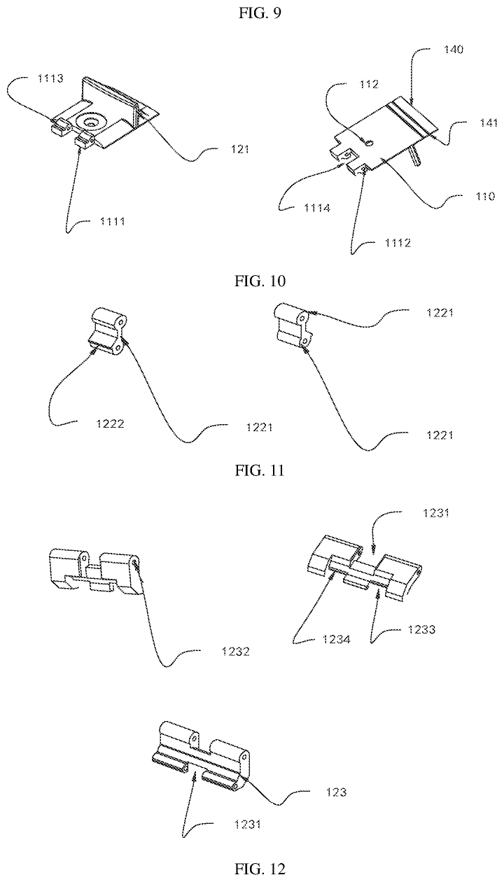

References are made to FIG. 6 to FIG. 9. As shown in FIG. 6 to FIG. 9, in some embodiments, the shower door 1 includes two glass doors 200, the sliding component 20 includes two guide grooves 210 in one-to-one correspondence with the two glass doors 200, and an end of the fixation plate 110 is provided with a hinge portion 111 in a horizontal direction. The guide portion 120 includes a guide plate 121. The guide plate 121 is arranged on a side of the fixation plate 110 away from the hinge portion 111, and the guide plate 121 extends vertically from the fixation plate 110 to a side away from the ground, and a free end of the guide plate 121 away from the fixation plate 110 is located in a corresponding guide groove 210, so that the guide groove 210 is slidable along a length direction of the guide plate 121. The guide portion 120 further includes a connecting rod 122 and a self-locking sheet 123. An end of the connecting rod 122 is hinged to the hinge portion 111, and the other end of the connecting rod 122 is hinged to the self-locking sheet 123. The connecting rod 122 is switched between being parallel to the fixation plate 110 and being perpendicular to the fixation plate 110 by rotating the connecting rod 122 relative to the hinge portion 111. In a case that both the connecting rod 122 and the self-locking sheet 123 are rotated to be perpendicular to the fixation plate 110, a free end of the self-locking sheet 123 away from the connecting rod 122 is located in a corresponding guide groove 210, allowing the guide groove 210 to be slidable along a length direction of the self-locking sheet 123.

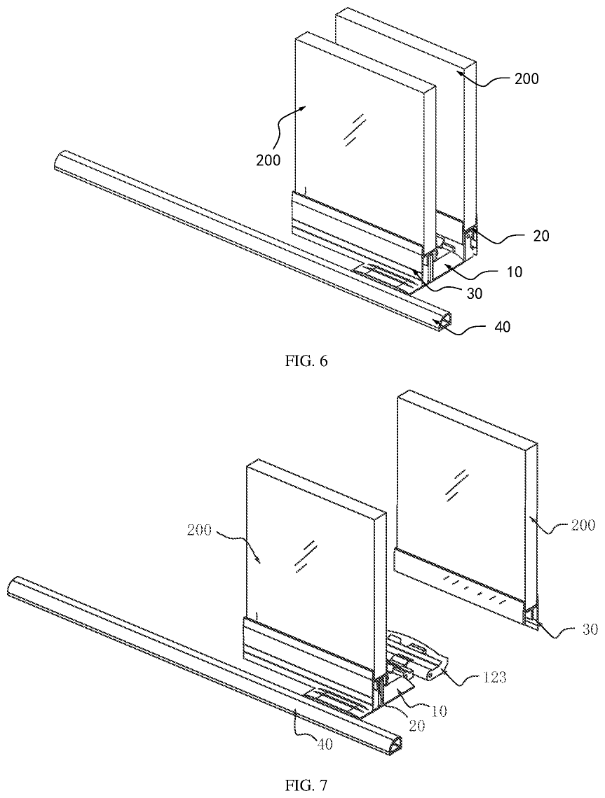

It should be noted that as the connecting rod 122 is hinged to the hinge portion 111 and the self-locking sheet 123, the movement of the glass door 200 can be satisfied and the guide portion 120 can be freely disassembled. Moreover, through the rotation of the connecting rod 122 relative to the hinge portion 111 and the rotation of the self-locking sheet 123 relative to the connecting rod 122, the shower door 1 can be easily mounted, cleaned, and maintained. For example, referring to FIG. 7, in a case that the connecting rod 122 and the self-locking sheet 123 are both rotated to be parallel to the fixation plate 110, the glass door 200 mounted on the self-locking sheet 123 can be released from the restriction of the guide portion 120, and the glass door 200 can be detached away from the glass door 200 mounted on the guide plate 121. Hence, the two glass doors 200 and the sliding structure 100 can be cleaned independently to avoid bacteria breeding and improve convenience. Moreover, in a case that the connecting rod 122 and the self-locking sheet 123 are both rotated to be parallel to the fixation plate 110, the fixation component 10 can be mounted and detached easily due to the lack of vertical restriction from the self-locking sheet 123 and the connecting rod 122. Hence, quick mounting of the sliding structure 100 is realized.

A height of the guide plate 121 and a height of the self-locking sheet 123 may be the same or different, which is to be set according to an actual situation, as long as the following condition is satisfied: the height of the water blocking plate 30 corresponding to the guide plate 121 being greater than the height of the guide plate 121; the height of the guide plate 121 being greater than the height of the corresponding first side plate 201; and in a case that the self-locking sheet 123 is perpendicular to the fixation plate 110, the height of the water blocking plate 30 corresponding to the self-locking sheet 123 being greater than the height of the self-locking sheet 123, and the height of the self-locking sheet 123 being greater than the corresponding first side plate 201.

Reference is further made to FIG. 11 and FIG. 12. FIG. 11 shows a schematic view of an alternative structure of a connecting rod viewed from a first perspective and a second perspective according to an embodiment of the present application. FIG. 12 shows schematic views of two alternative structures of a self-locking sheet according to an embodiment of the present application. Two ends of the connecting rod 122 are provided with connecting portions 1221 configured to be hinged to the hinge portion 111 and the self-locking sheet 123, respectively. A blocking tooth 1222 is provided at any of the connecting portions 1221, and the blocking tooth 1222 performs a function of stopper when the blocking tooth 1222 is in contact with the main plate 230, in order to prevent the self-locking sheet 123 from rotating beyond a preset angle.

In some embodiments, the hinge portion 111 includes two bosses 1111 which are spaced apart, and a first recess 1114 is formed between the two bosses 1111. A first reaming 1112 is defined on each of the bosses 1111 in the moving direction, and a positioning recess 1113 is defined on at least one of the bosses 1111 on a side away from the ground.

A second recess 1231 is defined at an end of the self-locking sheet 123, and a second reaming 1232 is defined in the moving direction. Two notches are defined at the free end of the self-locking sheet 123, and a limiting tooth 1234 is provided at a bottom of at least one of the notches. In a case that the self-locking sheet 123 is perpendicular to the fixation plate 110, the limiting tooth 1234 is in contact with the positioning recess 1113 to keep the self-locking sheet 123 perpendicular to the fixation plate 110.

During mounting, the connecting portion 1221 at one end of the connecting rod 122 is arranged in the first recess 1114 and hinged to the first reaming 1112 to realize hinge connection between the connecting rod 122 and the hinge portion 111, and the connecting portion 1221 at the other end of the connecting rod 122 is arranged in the second recess 1231 and hinged to the second reaming 1232 to realize hinge connection between the connecting rod 122 and the self-locking sheet 123.

In some embodiments, second recesses 1231 are defined at both ends of the self-locking sheet 123, and a second reaming 1232 is defined in the moving direction. A specific structure of the self-locking sheet 123 may be determined according to an actual situation, which is not specifically limited here.

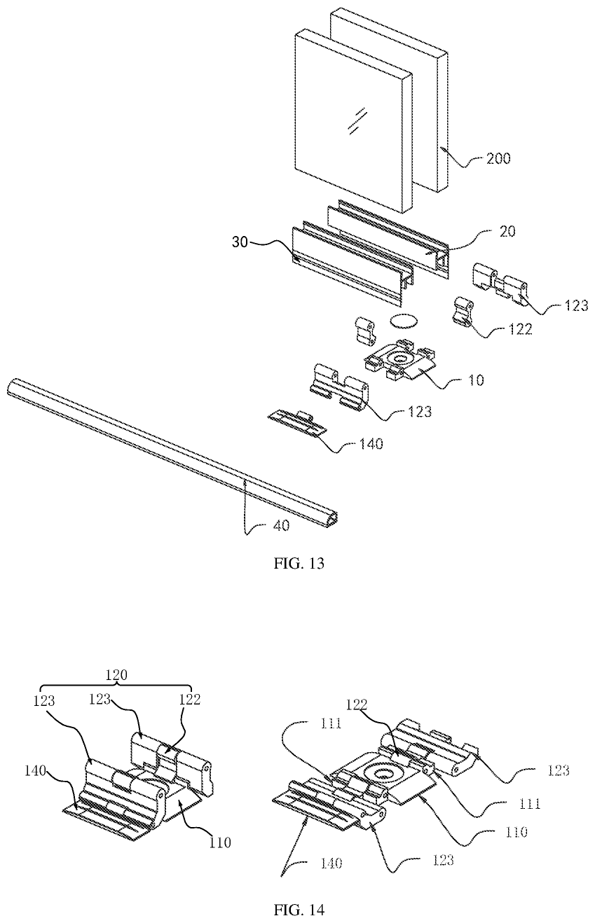

Reference is further made to FIG. 13 to FIG. 15. FIG. 13 shows a third exploded view of a quick-mount shower door sliding structure comprising a short water blocking member according to an embodiment of the present application. FIG. 14 shows a schematic view of a second alternative structure of a fixation component and a guide portion after assembly according to an embodiment of the present application. FIG. 15 shows a schematic view of an alternative structure of the fixation component in FIG. 14 viewed from a first perspective and a second perspective. The shower door 1 includes two glass doors 200. The sliding component 20 includes two guide grooves 210 in one-to-one correspondence with the two glass doors 200. The fixation component 10 further includes two hinge portions 111 arranged in a horizontal direction at two ends of the fixation plate 110 respectively. The guide portion 120 further includes two connecting rods 122 in one-to-one correspondence with the two hinge portions 111. One of the connecting rods 122 has an end hinged to one of the hinge portions 111, and the connecting rod 122 is switched between being parallel to the fixation plate 110 and being perpendicular to the fixation plate 110 by rotating the connecting rod 122 relative to the hinge portion 111. The guide portion 120 further includes two self-locking sheets 123 in one-to-one correspondence with the two connecting rods 122. One of the self-locking sheets 123 has an end hinged to the other end of the one of the connecting rods 122, and the self-locking sheet 123 is switched between being parallel to the fixation plate 110 and being perpendicular to the fixation plate 110 by rotating the self-locking sheet 123 relative to the connecting rod 122. In a case that the connecting rod 122 and the self-locking sheet 123 corresponding to the connecting rod 122 are both rotated to be perpendicular to the fixation plate 110, a free end of the self-locking sheet 123 away from the connecting rod 122 is located in a corresponding guide groove 210, allowing the guide groove 210 to be slidable along a length direction of the self-locking sheet 123.

By providing the guide portion 120 as the two hinge portions 111 and the two connecting rods 122, the two glass doors 200 mounted on the guide portion 120 can be released from restriction of the guide portion 120, as long as the hinge portions and the connecting rods 122 of the glass doors 200 are correspondingly arranged parallel to the fixation plate 110. As a glass door 200 is released from restriction of a guide portion 120, the glass door can be detached, so that the glass door 200 and the sliding structure 100 can be easily cleaned. The two glass doors 200 can be detached simultaneously or individually, or only one of the two glass doors 200 can be detached, which may be arranged according to an actual situation. In addition, in a case that the connecting rod 122 and the self-locking sheet 123 are both rotated to be parallel to the fixation plate 110, the fixation component 10 can be mounted and detached easily due to the lack of vertical restriction from the self-locking sheet 123 and the connecting rod 122. Hence, quick mounting and detachment of the sliding structure 100 is realized

Specific structures of the two self-locking sheets 123 may or may not be completely identical, and may be specifically configured according to an actual situation, which is not specifically limited here.

Specific details of the self-locking sheet 123, the connecting rod 122 and the hinge portion 111 may be referred to the above contents, which are not repeated here.

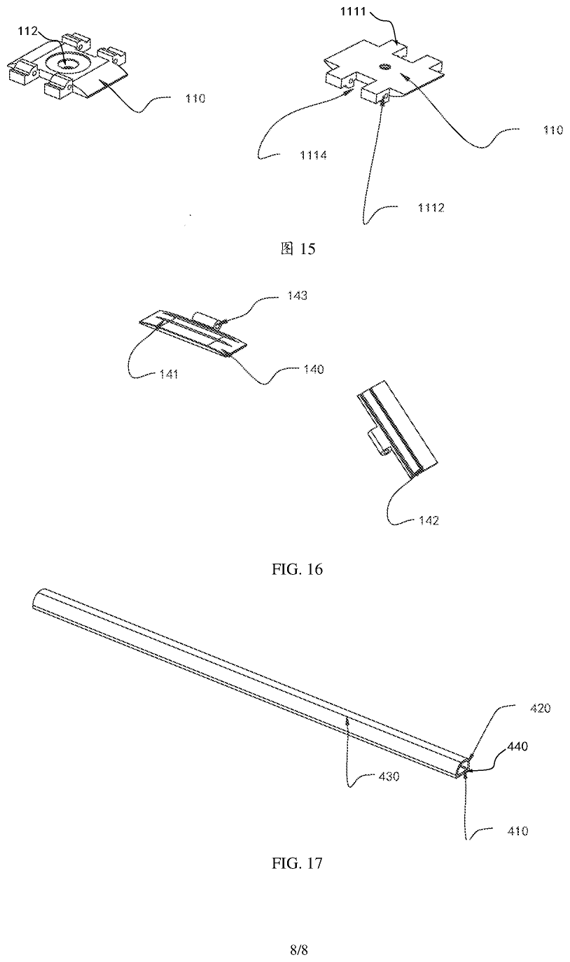

Reference is further made to FIG. 16 and FIG. 17. FIG. 16 shows a schematic view of an alternative structure of a limiting member viewed from a first perspective and a second perspective according to an embodiment of the present application. FIG. 17 shows a schematic view of an alternative structure of a water baffle according to an embodiment of the present application. The fixation component 10 further includes a limiting member 140 arranged at an end of the fixation plate 110 away from the guide portion 120. The sliding structure 100 further includes a water baffle 40, which is arranged on the limiting member 140 to prevent water from flowing out from the bottom of the shower door 1. A length of water baffle 40 may be greater than a length of the water blocking plate 30. A specific length of the water baffle 40 may be set according to an actual situation, and is not specifically limited here.

In some embodiments, the limiting member 140 may be integrally formed with the fixation plate 110.

In some embodiments, the limiting member 140 includes a connecting member 143, and the limiting member 140 is detachably connected with the fixation plate 110 through the connecting member 143. A specific connection mode between the limiting member 140 and the fixation plate 110 may be determined according to an actual situation, and is not specifically limited here.

In some embodiments, the limiting member 140 includes multiple limiting ribs 141 arranged in a direction perpendicular to the moving direction. By arranging the water baffle 40 on different limiting ribs 141, a distance between the water baffle 40 and the water blocking plate 30 can be adjusted to adjust the water blocking effect according to an actual situation. In other embodiments, the limiting member 140 further includes a cut groove 142, and the distance between water baffle 40 and the water blocking plate 30 can be adjusted by removing a part of the limiting member 140 through the cut groove 142.

In some embodiments, the water baffle 40 includes a baseplate 410 and a faceplate 420. The baseplate 410 is configured to be in contact with the ground, and the faceplate 420 is arranged on a side of the baseplate 410 away from the ground. The baseplate 410 includes a first side surface close to the water blocking plate 30 and a second side surface away from the water blocking plate 30. A bottom surface of the faceplate 420 is connected with the first side surface, and a top surface of the faceplate 420 is connected with the second side surface through an arc surface 430. Connection through the arc surface 430 can increase comfort of contact with people, and thereby the user is protected from injuring the toes. In addition, since the sliding structure 100 is provided with the water blocking plate 30, the height of the water baffle 40 may be set low, so that the user is further protected from injuring the toes.

In some embodiments, multiple toothed structures are further provided on a side of the baseplate 410 in contact with the ground, to increase a contact area between the baseplate 410 and the ground, so that the water blocking effect is further improved.

In some embodiments, a through hole 112 is defined between the two guide plates 1221 on the fixation plate 110, for mounting the fixation component 10 on the ground via the through hole 112. For example, a bolt is passed through the through hole 112, to press the fixation plate 110 against the ground. In other embodiments, the sliding structure further includes a cover body 50, which is mounted on the through hole 112 for decorating the fixation plate 110.

In other embodiments, the fixation component 10 may be mounted on the ground by adhesive. To adhering, a slow adhesive is sprayed on an adhesive surface, which is then adhered automatically after adjustment.

In another aspect, a shower door 1 is further provided according to an embodiment of the present application. The shower door 1 includes the sliding structure 100 according to any of the above-described embodiments and a glass door 200, where the glass door 200 is located in the mounting groove 220.

In summary, in the quick-mount shower door sliding structure 100 comprising a short water blocking member and the shower door 1 including the same provided according to the present application, the sliding component 20 is slidable relative to the fixation component 10 through the sliding fit between the guide groove 210 in the sliding component 20 and the guide portion 120 in the fixation component 10. The mounting groove 220 is connected with the water blocking plate 30, so that the contact of the water blocking plate 30 with the ground can prevent water from flowing out from the bottom of the shower door 1. Therefore, the sliding structure 100 according to the embodiments can have a water blocking effect when the shower door 1 moves, so that leakage of water in a shower room to the exterior due to movement of the shower door 1 is avoided.

Although some embodiments and variations of the present application have been described in detail, it should be understood by those skilled in the art that the present application is not limited to the embodiments and variations described above, but may include other various possible conjunctions and combinations. Other variations and modifications can be implemented by those skilled in the art without departing from the essence and scope of the present application. All the variations and modifications shall fall within the scope of the present disclosure. Moreover, all the members described herein can be replaced by other technically equivalent members.

1. A quick-mount shower door sliding structure (100) comprising a short water blocking member, wherein the sliding structure (100) comprises a fixation component (10), a sliding component (20) and a water blocking plate (30), wherein
the fixation component (10) comprises a fixation plate (110) and a guide portion (120), the fixation plate (110) is configured for mounting the sliding structure (100) on the ground, and the guide portion (120) is connected with the fixation plate (110);
the sliding component (20) comprises a guide groove (210) with an opening facing the ground and a mounting groove (220) with an opening facing away from the ground, the mounting groove (220) is configured to accommodate a lower portion of a movable door panel (200) of the shower door to fix the movable door panel (200), and the guide groove (210) is sleeved to the guide portion (120) in a case that the guide portion (120) is perpendicular to the fixation plate (110), allowing the guide groove (210) to be slidable along a length direction of the guide portion (120) and the movable door panel (200) to be slidable relative to the fixation plate (110); and
the water blocking plate (30) is connected with the mounting groove (220), and a bottom of the water blocking plate (30) is in contact with the ground, to block a gap between the sliding component (20) and the ground and prevent water from flowing out from a bottom of the shower door (1).

2. The sliding structure (100) according to claim 1, wherein
the sliding component (20) comprises a main plate (230), two first side plates (201) and two second side plates (202), the main plate (230) is parallel to the fixation plate (110), the two first side plates (201) are spaced apart on a side of the main plate (230) close to the ground, the two second side plates (202) are spaced apart on a side of the main plate (230) away from the ground, wherein the guide groove (210) is defined by the two first side plates (201) and the main plate (230), and the mounting groove (220) is defined by the two second side plates (202) and the main plate;
wherein the water blocking plate (30) and the first side plates (201) are spaced on a same side of the main plate (230), and the water blocking plate (30) is connected with a second side plate (202) located on an outer side of the movable door panel (200); and
wherein in a case that the guide portion (120) is perpendicular to the fixation plate (110), a height of the water blocking plate (30) is greater than a height of the guide portion (120), and a height of the guide portion (120) is greater than heights of the first side plates (201).

3. The sliding structure according to claim 2, wherein the water blocking plate (30) comprises a first portion (310) connected with the second side plates (202) and a second portion (320) in contact with the ground, and the second portion (320) is bent relative to the first portion (310) toward a side close to the guide portion (120).

4. The sliding structure (100) according to claim 2 or 3, wherein the water blocking plate (30) further comprises an adjusting member, the adjusting member is arranged between the first portion (310) and the second portion (320), and is configured to adjust the height of the water blocking plate (30) to adjust a sealing degree between the water blocking plate (30) and the ground.

5. The sliding structure (100) according to claim 4, wherein the fixation component (10) further comprises a limiting member (140) arranged on an end of the fixation plate (110) away from the guide portion (120);
the sliding structure (100) further comprises a water baffle (40) arranged on the limiting member (140) to prevent water from flowing out from the bottom of the shower door (1);
wherein the water baffle (40) comprises a baseplate (410) and a faceplate (420), the baseplate (410) is configured to be in contact with the ground, the faceplate (420) is arranged on a side of the baseplate (410) away from the ground, the baseplate (410) comprises a first side surface close to the water blocking plate (30) and a second side surface away from the water blocking plate (30), a bottom surface of the faceplate (420) is connected with the first side surface, and a top surface of the faceplate (420) is connected with the second side surface through an arc surface (430); and
a plurality of teeth (440) are provided on a side of the baseplate (410) in contact with the ground, to increase a contact area between the baseplate (410) and the ground.

6. The sliding structure (100) according to any one of claims 1 to 5, wherein the shower door (1) comprises two movable door panels (200), the sliding component (20) comprises two guide grooves (210) in one-to-one correspondence with the two movable door panels (200), and the fixation component (10) further comprises two hinge portions (111) horizontally arranged on two ends of the fixation plate (110) respectively;
the guide portion (120) further comprises two connecting rods (122) in one-to-one correspondence with the two hinge portions (111), one of the connecting rods (122) has an end hinged to one of the hinge portions (111), and the connecting rod (122) is switched between being parallel to the fixation plate (110) and being perpendicular to the fixation plate (110) by rotating the connecting rod (122) relative to the hinge portion (122);
the guide portion (120) further comprises two self-locking sheets (123) in one-to-one correspondence with the two connecting rods (122), one of the self-locking sheets (123) has an end hinged to the other end of the one of the connecting rods (122), and the self-locking sheet (123) is switched between being parallel to the fixation plate (110) and being perpendicular to the fixation plate (110) by rotating the self-locking sheet (123) relative to the connecting rod (122); and
in a case that the one of the connecting rods (122) and the self-locking sheet (123) corresponding to the connecting rod (122) are both rotated to be perpendicular to the fixation plate (110), a free end of the self-locking sheet (123) away from the connecting rod (122) is located in a corresponding one of the guide grooves (210), allowing the guide groove (210) to be slidable along a length direction of the self-locking sheet (123).

7. The sliding structure (100) according to any one of claims 1 to 5, wherein the shower door (1) comprises two movable door panels (200), the sliding component (20) comprises two guide grooves (210) in one-to-one correspondence with the two movable door panels (200), and an end of the fixation plate (110) is provided with a hinge portion (111) in a horizontal direction;
the guide portion (120) comprises a guide plate (121), the guide plate (121) is arranged on a side of the fixation plate (110) away from the hinge portion (111), and the guide plate (121) extends vertically from the fixation plate (110) to a side away from the ground, and a free end of the guide plate (121) away from the fixation plate (110) is located in a corresponding one of the guide grooves (210), allowing the guide groove (210) to be slidable along a length direction of the guide plate (121);
the guide portion (120) further comprises a connecting rod (122) and a self-locking sheet (123), an end of the connecting rod (122) is hinged to the hinge portion (111), the other end of the connecting rod (122) is hinged to the self-locking sheet (123), the connecting rod (122) is switched between being parallel to the fixation plate (110) and being perpendicular to the fixation plate (110) by rotating the connecting rod (122) relative to the hinge portion (111), and the self-locking sheet (123) is switched between being parallel to the fixation plate (110) and being perpendicular to the fixation plate (110) by rotating the self-locking sheet (123) relative to the connecting rod (122); and
in a case that the connecting rod (122) and the self-locking sheet (123) are both rotated to be perpendicular to the fixation plate (110), a free end of the self-locking sheet (123) away from the connecting rod (122) is located in a corresponding one of the guide grooves (210), allowing the guide groove (210) to be slidable along a length direction of the self-locking sheet (123).

8. The sliding structure (100) according to any one of claims 1 to 5, wherein the shower door (1) comprises two movable door panels (200), and the sliding component (20) comprises two guide grooves (210) in one-to-one correspondence with the two movable door panels (200);
the guide portion (120) comprises two guide plates (121), the two guide plates (121) are spaced apart on the fixation plate (110), each guide plate (121) extends vertically from the fixation plate (110) toward a side away from the ground, and a free end of each guide plate (121) away from the fixation plate (110) is located in a corresponding one of the guide grooves (210), allowing the guide groove (210) to be slidable along a length direction of the guide plate (121).

9. The sliding structure (100) according to claim 6, wherein a positioning recess (1113) is defined on a side of each hinge portion (111) away from the ground;
two notches (1233) are defined at the free end of each self-locking sheet (123), and a limiting tooth (1234) is provided at a bottom of at least one of the notches (1233); and
in a case that the self-locking sheet (123) is perpendicular to the fixation plate (110), the limiting tooth (1234) is in contact with the positioning recess (1113) to keep the self-locking sheet (123) perpendicular to the fixation plate (110).

10. A shower door (1), comprising the quick-mount shower door sliding structure (100) comprising a shower water blocking member according to any one of claims 1 to 9 and a movable door panel (200), wherein the movable door panel (200) is located in the mounting groove (220).
